(19) United States
(12) Patent Application Publication
(10) Pub. No.: US 2017/0206427 A1
(43) Pub. Date: Jul. 20, 2017

(54) Efficient, High-Resolution System and Method to Detect Traffic Lights

(71) Applicant: Sportstech LLC, Eugene, OR (US)

(72) Inventor: Matthew Leigh Ginsberg, Eugene, OR (US)

(21) Appl. No.: 15/473,177

(22) Filed: Mar. 29, 2017

Related U.S. Application Data
(63) Continuation-in-part of application No. 14/820,345, filed on Aug. 6, 2015.
(60) Provisional application No. 62/106,146, filed on Jan. 21, 2015.

(51) Int. Cl. G06K 9/00; G06K 9/46

(52) U.S. Cl. CPC G06K 9/00825; G06K 9/4652

(57) ABSTRACT

A traffic light identification system and method uses high resolution digital video information to determine presence and location of traffic lights in order to enable vehicular safety systems and control of autonomous vehicles. Candidate image portions are identified, pruned and scored in a computationally-efficient manner. Temporal and spatial techniques remove artifacts such as brake lights and pedestrian signals from consideration.

### CROSS REFERENCE TO RELATED APPLICATIONS

This application is a continuation in part of U.S. patent application Ser. No. 14/820,345, filed Aug. 6, 2015, which claims the benefit of U.S. Provisional Application No. 62/106,146, filed Jan. 21, 2015, both of which are incorporated herein by reference in their entirety.

### BACKGROUND

1. Technical Field

The subject matter described herein generally relates to vehicular safety systems, and in particular to use of real-time visual detection of traffic lights in high resolution images using a standard CPU.

2. Background Information

Traffic light detection is an important problem faced by both forthcoming Advanced Driver Assistance Systems (ADAS) and future autonomous vehicles. Autonomous vehicles will need to interact with traffic lights; while there has been some discussion that traffic lights may disappear as human drivers do, it seems likely that traffic signals will survive, since they are needed not only for vehicles but for pedestrians and bicyclists as well.

Autonomous vehicles can interact with traffic lights in one of two ways. First, they can use data provided by the traffic signal itself, either through Dedicated Short Range Communication (DSRC) or using an Internet-based mechanism. Second, vehicles can make use of cameras to observe the traffic lights.

In recent years, there has been increasing research in visual traffic light detection using various color segmentation and feature detection algorithms, as well as recent advances using convolutional neural networks (CNNs). Unfortunately, much of the existing work has significant drawbacks, making it unsuitable for deployment in the real world. Practical problems include issues related to robustness, reliance on potentially out-of-date prior information, detection speed, computational requirements, and scalability to higher resolution cameras.

Practical traffic light detection must operate in a wide range of environments, and with multiple traffic light designs. A new and temporary light in a construction zone is unlikely to exist in a geospatial database. A rural area may area may graduate to being a (literal) one-light town and add a new traffic light but simply not tell anyone. In all of these cases, a signal may appear unexpectedly in the visual field, and an autonomous vehicle will need to handle it. Traffic light detection systems will need to operate without complete prior knowledge of light locations, and without generating false positives from lights on vehicles or buildings.

Cameras typically capture video at 30 frames per second (fps) or more, and there are two reasons why traffic light detection systems need to keep up. First, while a system operating at (say) 3 fps may be sufficient to observe a light long before a vehicle needs to interact with it, there may be aliasing between the frequency of frame analysis and the frequency of, for example, a flashing yellow signal. In the worst case, the two frequencies will coincide and the flashing light will be perceived as either always on or always off. More importantly, however, no computer vision system is perfect. A system that detects lights in single frames with 80% accuracy has about a 1% chance of missing a traffic light after analyzing three frames. If the analysis proceeds at a rate of 3 fps, that is probably unacceptable; a 1% chance of not seeing a light for a full second (or a flashing yellow for double that) is simply unsafe. A system that operates at 30 fps would have less than one chance in a billion of missing a traffic light for a full second, even if its detection rate on individual images were only 50%.

Existing work has also utilized low resolution images, typically 640×480 pixels, due to computational requirements. Again, this introduces significant risk that the detection will be insufficient for modern requirements, whether due to false positives (e.g., falsely detecting a green light) or false negatives (e.g., not detecting an upcoming red light). For light detection to be usable and cost-effective in desired safety systems and autonomous vehicle control subsystems, improvements in the task of traffic light detection are needed.

### BRIEF DESCRIPTION OF THE DRAWINGS

FIG. (FIG. 1 is a high-level block diagram illustrating a networked computing environment suitable for providing image processing to identify traffic lights, according to one embodiment.

FIG. 2 is a symbolic representation of an implementation of a vehicular-based traffic light identification system, according to one embodiment.

FIG. 3 is a high-level block diagram illustrating a data processing device, such as the one in FIG. 1, according to one embodiment.

FIG. 4 is a flow-chart illustrating a method for identifying traffic lights, according to one embodiment.

FIG. 5 is a high-level block diagram of an exemplary computing device, according to one embodiment.

### DETAILED DESCRIPTION

The Figures and the following description describe certain embodiments by way of illustration only. One skilled in the art will readily recognize from the following description that alternative embodiments of the structures and methods illustrated herein may be employed without departing from the principles described herein. Reference will now be made to several embodiments, examples of which are illustrated in the accompanying figures. It is noted that wherever practicable similar or like reference numbers may be used in the figures and may indicate similar or like functionality.

In summary, the traffic light detection systems and methods described here address the technical needs outlined above while also moderating deployment costs. In one embodiment, a system analyzes 4K (3840×2160) video at approximately 30 fps running on a single mid-range desktop CPU and without requiring prior information. This facilitates detection of lights at long distances while utilizing a camera with a wide field of view, enabling the perception of lights when stopped at the white line. A wide field of view also enables additional visual analysis in other applications such as collision avoidance while using only a single camera system.

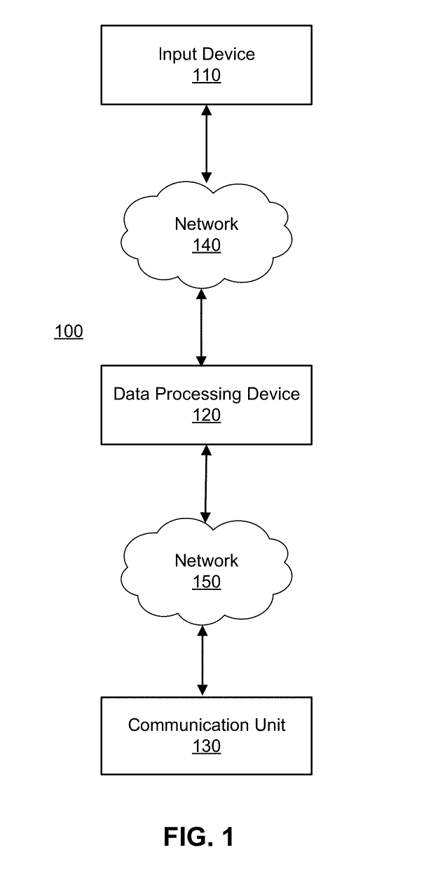

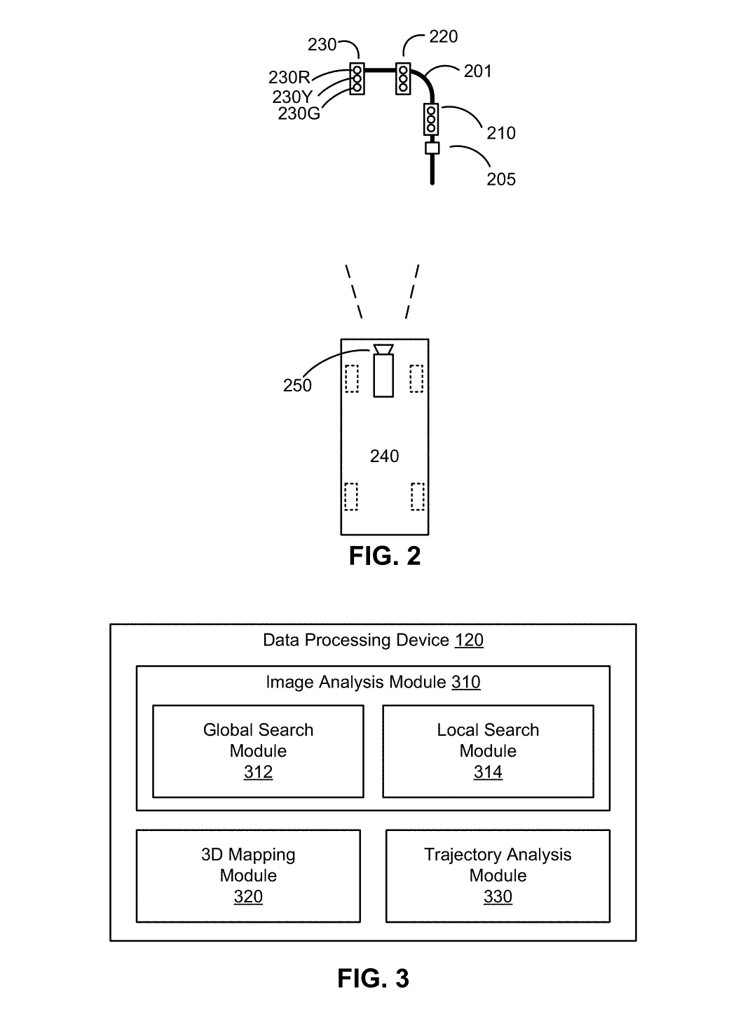

FIG. 1 illustrates one embodiment of a system 100 for identifying traffic lights. In the embodiment shown, system 100 includes, at a high level, an input device 110, a data processing device 120 connected to the input device via a network 140, and a communication unit 130 connected to the data processing device 120 via a network 150. In the embodiments discussed here, input device 110 is a digital video camera discussed in greater detail with respect to FIG. 2 below. Data processing device 120 is a multi-threaded processing system discussed in greater detail with respect to FIG. 3 below. In one embodiment particularly suited for testing and prototyping purposes, the data processing device 120 is a MACBOOK PRO™ laptop computer with a 2.7 GHz INTEL i7 processor capable of running eight processes in parallel. In other embodiments, the data processing device 120 has different specifications. Communication unit 130 is an additional subsystem that processes information related to traffic lights identified by data processing device 120, for example communications to command that the brakes of an autonomous vehicle be activated to bring the vehicle to a stop at a red light.

In some environments, networks 140 and 150 are WAN networks, while in others the connections they provide may be implemented by conventional LAN Ethernet, Wi-Fi, USB or other conventional connections between processing subsystems. In additional embodiments for various applications, the networks 140 and 150 employ links using technologies such as Ethernet, 802.11, worldwide interoperability for microwave access (WiMAX), 2G/3G/4G mobile communications protocols, digital subscriber line (DSL), asynchronous transfer mode (ATM), InfiniBand, PCI Express Advanced Switching, etc. Similarly, the networking protocols used on the networks 140 and 150 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), etc. as may be most suitable for the application at hand. The data exchanged over the networks 140 and 150 can be represented using technologies and formats including image data in binary form (e.g., Portable Network Graphics (PNG)), hypertext markup language (HTML), extensible markup language (XML), etc. In addition, all or some of the links can be encrypted using conventional encryption technologies such as secure sockets layer (SSL), transport layer security (TLS), virtual private networks (VPNs), Internet Protocol security (IPsec), etc. to address issues such as potential hacking threats. In another embodiment, the entities coupled via networks 140 or 150 use custom or dedicated data communications technologies instead of, or in addition to, the ones described above. Although FIG. 1 shows the various elements communicating via two networks 140 and 150, in some embodiments, the elements communicate via a single network, such as the Internet. In some embodiments, the components are directly connected using a dedicated communication line or wireless link, such as optical or RF. In a typical embodiment, most if not all of the described components of system 100 are implemented within the vehicle 240 described below, so conventional wired connections among the various components are used.

In other embodiments, the system 100 contains different and/or additional elements. In addition, the functions may be distributed among the elements in a different manner than described herein. For example, the input device 110 may perform some or all of the data processing related to the input it provides, such as described below with respect to video conversion.

Referring now to FIG. 2, in one embodiment, a conventional vehicle-mounted high resolution video camera 250 serves as an input device (corresponding to input device 110 of FIG. 1) and captures video in front of vehicle 240. In some embodiments, the camera 250 is configured to capture 4K video at 30 fps with a focal length of 50 mm (in one particular embodiment particularly suited for testing and prototyping, a Sony PW FS7 camera with a SONY 24-70 mm f/4 Vario Tessar T FE OSS lens set at 50 mm) so that the field of view (represented in FIG. 2 by dashed lines extending outward from vehicle 240) is approximately 1 radian. Those skilled in the art will appreciated that based on mounting locations and specific applications, other settings may be more appropriate. In one embodiment, the video is compressed by camera 250 into the AVCHD format, converted into h.264 using VLC, and then split into individual uncompressed frames using OpenCV. In a second embodiment, camera 250 provides a direct HDMI output to a BLACMAGIC DESIGN® 4K video processor device, which produces output for further processing by data processing device 120 via a conventional Thunderbolt connection. Again, those skilled in the art will appreciate that other configurations and video conversion facilities (e.g., any general purpose h.264 video converter) may be suitable depending on the specific application. In the described embodiment, an exposure adjustment of −1.5 stops is employed to ensure that the traffic signals do not over-expose into “bright white,” losing essential color information. Such video, if viewed on a standard display, would appear darker than typical but this could be corrected for if the video stream were used in additional applications with only a minor loss of detail in the darkest tones.

In the described embodiment, it is considered acceptable to detect only traffic lights of radius four pixels or greater; given the geometry as described above, this corresponds to a traffic light distance of approximately 450 feet.

Referring still to FIG. 2, there is a representation of a traffic light structure 201 attached to which are traffic signals 210, 220, 230 and pedestrian signal 205. This figure is used to explain methods used to detect individual traffic lights, e.g., 230R for the red light of traffic signal 230, 230Y for the yellow (or amber) light of traffic signal 230, and 230G for the green light of traffic signal 230. Notable characteristics of each of such lights are that they are generally unobscured and large enough to be seen as clearly circular in shape. As will readily be understood, while such lights are of a limited range of colors, they may still be somewhat challenging to discriminate from other features. For instance, green is a color that in video is often is very similar to the color of the background sky, amber is a color used in many vehicular parking/signal lights, and red is a color used in vehicular brake lights as well as in, for example, pedestrian signal 205. Further on this last point, particularly when traffic signals are at a distance, such other features in an image may readily be confused with a traffic light.

Accurately identifying a traffic light in a typical street image is a task that is daunting for a conventional single-CPU computing system. A single 4K image will contain about 8 million pixels. Analyzing a 30 fps 4K feed will therefore involve dealing with approximately 240 million pixels per second, with each pixel containing 3 bytes of information. This is a number that is likely to be impractical in practice for real-time processing. It is for this reason that known attempts at addressing this problem have relied on lower resolution images. As explained above, this is unsatisfactory for reliable real-time identification of traffic lights suitable for vehicular safety systems and autonomous vehicle control.

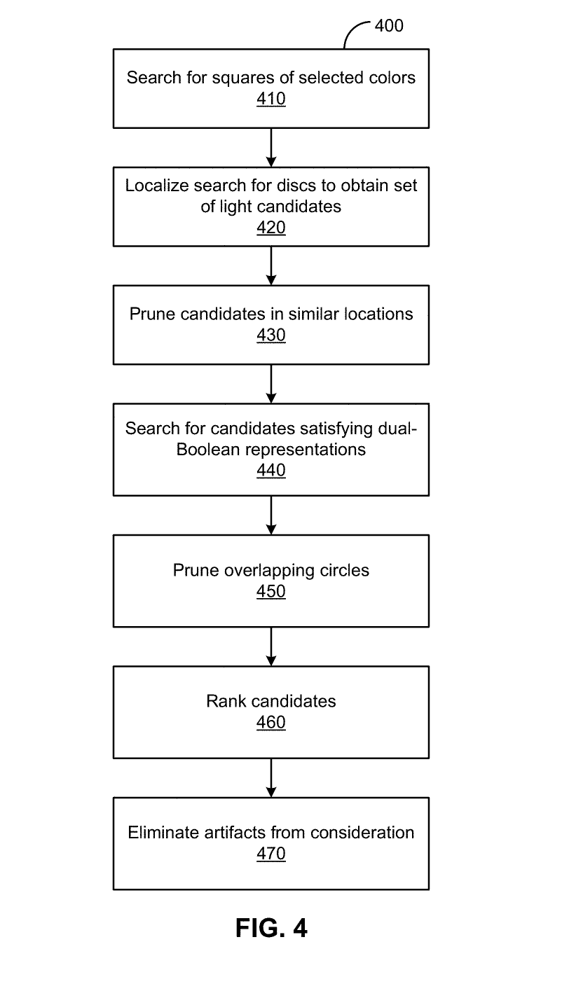

Referring now to FIG. 3, in one embodiment, data processing device 120 is a computing system with an image analysis module 310 that makes use of both a global search module 312 and a local search module 314 to provide analysis of portions of images within a multithreaded architecture, as well as 3D mapping module 320 and trajectory analysis module 330 that are used to filter out artifact candidates in order to reduce false positive and false negative results, as further detailed below. Specifically, a global thread analyzes entire images to identify regions of interest, subimages of the original images that appear to contain traffic lights. In one embodiment this global thread operates at a rate of approximately 15 fps, in other words analyzing some but not all of the captured frames. The identified subimages are then evaluated further by a separate local thread. Since the local thread needs to examine only a relatively small portion of the overall image, it can easily operate at speeds of 30 fps or greater, i.e., a greater proportion of the captured frames. In one embodiment, the local thread reanalyzes images considered by the global thread so that if (for example) the global thread finds a light in one analyzed frame but then misses it in the next analyzed frame, the local thread has an opportunity to overcome this problem. Because the local thread in general needs to analyze subimages that are only relatively small portions of the overall image, the computational requirements of the local thread can be expected to be insignificant when compared to the global thread. This means that the local and global threads can run simultaneously. In one embodiment, the local thread analyzes only subimages of those images that have been skipped by the global thread (which is not operating at 30 fps and must therefore ignore some frames). In another embodiment, the local thread analyzes its subimages with slightly different parameters than the global thread, so that if a traffic light is missed by the global thread, the local thread may be able to identify it. In this latter embodiment, the local thread analyzes subimages in all of the frames, whether the global thread has analyzed them or not. Both the local and global threads are faced with a similar computational task: find traffic lights in a given image. The overall nature of the problem being solved can therefore be broken down into two separable subproblems: first, finding traffic lights quickly in an image and second, identifying a region of interest in one image after a light has been found in another image. A method 400 used to address these subproblems in one embodiment is illustrated in FIG. 4. Note that while traffic lights themselves are largely stationary (but not entirely, considering for instance minor movements that may occur in hanging traffic signals during windy weather), vehicles move dramatically and this can cause the apparent position of any particular light to change from one frame to the next. Notably, since movement is relative based on the reference frame of the observer, positional movement of an item from one frame to the next may be more indicative of a stationary object, and lack of movement may be more indicative of a moving object. For example, two cars moving on a highway at 65 miles per hour may nonetheless show little movement relative to one another, so tail lights of one such vehicle may appear to remain in about the same position from frame to frame in a video taken from the other vehicle's camera.

The initial processing task is to rapidly find colored circles in a stream of changing video images. This is a well-studied problem in the computational vision literature and is commonly solved using color blob detection or the circular Hough transform. While such techniques may be usable in some applications, in order to cope with high resolution images, the embodiment detailed here makes use of a faster algorithm that exploits the fact that the task is to look for circular discs.

Method 400 commences by searching 410 not for disks, but for squares of a particular color or set of colors (for instance, red, amber or green). After the squares are found, the system 100 uses them to localize 420 the search for appropriately colored disks. In the embodiment detailed here, the pixel data is stored in the YUV format typical of raw video encoding, and because the primary means by which traffic lights stand out is luminance, corresponding to the Y value. An RGB encoding would make this harder to identify. The common HSV space also separates brightness (the V values) but requires an additional transform of the native video color-space. In testing, it was discovered that approximately 14 ms is required (using the described processor architecture) to transform a 4K image from YUV to HSV color-space, an overhead that is preferably avoided.

When searching for a square of a particular color, the system identifies that color by a range of possible values for each of Y, U and V. For each point (x,y) in the image, h(x,y) is defined as the number of traffic light colored pixels in a square of size s with upper left corner at (x,y). The algorithm takes s to be the size of the largest square that can be inscribed in a circle of radius four pixels, since each traffic signal is required to be at least that large by the system. Further consideration is given only to those points (x,y) for which h(x,y) exceeds some threshold t.

This approach has two notable properties. First, it is possible to compute h(x,y) for every pixel in the image extremely quickly. Second, it is possible to optimize the colors being searched for and the threshold t so that the overall process suggests a minimal number of squares for further evaluation.

For the first, suppose that hᵣ(x,y) is denoted as the number of appropriately colored pixels in a region that is not a square of size s, but is instead a row of length s. Now if p(x,y) is denoted as the function that takes the value 1 if the pixel at (x,y) is traffic-light colored and 0 if it is not, this yields the equation:

hᵣ(x,y)=hᵣ(x−1,y)+p(x+s,y)−p(x−1,y)

since the region starting at (x,y) differs from that starting at (x−1,y) only in that the pixel at (x+s,y) is now included and the pixel at (x−1,y) no longer is. This dynamic programming approach allows the system to compute the entire row of hᵣ(x,y) values for a fixed x using only two operations per pixel. The process of computing h(x,y) for each (x,y) in the image can also be perfectly parallelized, since each row is treated separately. The image can be divided into n horizontal strips, facilitating processing across multiple CPU threads of data processing device 120. An alternative embodiment works instead with h_{c}(x,y), the number of suitably colored pixels in a column of the image. Which of these two embodiments is to be used is a function of the memory layout used to store the images in question.

Having computed hᵣ(x,y), h(x,y) is computed as

h(x,y)=h(x,y−1)+hᵣ(x,y+s)−hᵣ(x,y−1)

since the square region starting at (x,y) differs from that starting at (x,y−1) only in that the row at (x,y+s) is now included and the row at (x,y−1) no longer is. Again using a dynamic programming approach, h(x,y) can be computed using an additional two operations per pixel. If h_{c}(x,y) is used instead of hᵣ(x,y), a similar approach can be taken.

To minimize the number of pixels that need to be considered as possible traffic lights there are seven parameters to optimize: the minimum and maximum values for the luminance Y-value, yₘᵢₙ and yₘₐₓ, and similar parameters for the U and V chroma values. There is also the threshold parameter t.

Note first that given a set of images in which traffic lights have been identified by hand, it is possible to compute t from the other six parameters. After all, t should be the maximum threshold for which the known traffic lights do indeed qualify as lights. The system therefore optimizes only yₘᵢₙ, yₘₐₓ, uₘᵢₙ, uₘₐₓ, vₘᵢₙ and vₘₐₓ.

For some fixed image I, the total number of pixels identified as possible traffic light locations in I is denoted by N(I, yₘᵢₙ, yₘₐₓ, uₘᵢₙ, uₘₐₓ, vₘᵢₙ, vₘₐₓ), given values for yₘᵢₙ, yₘₐₓ, uₘᵢₙ, uₘₐₓ, vₘᵢₙ and vₘₐₓ. By averaging this expression over various images representative of those that will be analyzed when the system 100 is operating in real time, the algorithm can employ a new function that we denote simply by N(yₘᵢₙ, yₘₐₓ, uₘᵢₙ, uₘₐₓ, vₘᵢₙ, vₘₐₓ). This function represents the expected number of points that will need to be analyzed further in a new and not yet known image.

The goal is now to choose values for yₘᵢₙ, yₘₐₓ, uₘᵢₙ, uₘₐₓ, vₘᵢₙ and vₘₐₓ that minimize N. In the described embodiment, a conventional hill-climbing approach is used to select such values.

Having identified yₘᵢₙ, yₘₐₓ, uₘᵢₙ, uₘₐₓ, vₘᵢₙ and vₘₐₓ for each of the three light colors (red, yellow and green) using a training data set, associated thresholds t for each of the colors are computed as well. The system 100 can then identify all of the pixels in our image that satisfy h(x,y)≧t; each such point is the upper left-hand corner of a square centered at the possible center of a traffic light. The result of this process is thus a set of candidate centers of traffic lights. In typical use, hundreds if not thousands of candidates may result, including not only the actual traffic lights of interest but other features to be treated as artifacts, such as vehicular lights and pedestrian signals, as well.

The next step is to prune 430 the set of candidate centers to reduce the amount of subsequent processing required. If two candidates are in virtually identical positions with one appearing to be better than the other (in that the value of h(x,y) is higher), the worse candidate is pruned.

In the next stage of analysis, the image is converted in one or more separate ways into a Boolean representation, where each pixel is either on or off. One such manner is to convert an original image to one in which traffic light colored pixels are on and everything else is off.

A second possible manner in which the image can be converted to a Boolean representation is by using the Canny transform as detailed in Harris, C. and Stephens, M. (1988), “A combined corner and edge detector,” Fourth Alvey vision converence. 15, pp. 147-151, University of Manchester, the contents of which are incorporated by reference as if fully set forth herein. The Canny transform is designed to find edges in an image, and in this alternative manner may achieve a second Boolean representation.

The system 100 now searches 440 for circles that appear in all of the Boolean representations. To make this quantitative, suppose that p is the probability that a pixel is on in an image. Considering a circle centered at a point c and of radius r, there will be 2πr pixels associated with that circle. If the Boolean image were random, it would be expected that 2πrρ of those pixels would be on. If the circle is actually present in the image, many more will be. The system performs a probabilistic analysis to determine the probability that a circle observed in the image would appear randomly, and then defines the score of the circle to be the negative of the logarithm of that probability. In general, circles would not show up at all if the image were random, so the probabilities involved are quite small and a higher score thus corresponds to a better circle. The system combines weighted scores from the various Boolean representations to get an overall score for each possible circle under consideration. In one implementation, a color-thresholded image is weighted 60% and a Canny image is weighted 40% to get the overall score. The final set of circles is then pruned 450 so that if two circles overlap, only the one with the highest score is kept. This finally produces a highly reduced set of candidates that are ranked 460 based on their scores.

Because this second phase need consider only perhaps hundreds or thousands of possible centers out of 8 million pixels in the original image, virtually all of the computation time needed by this approach is consumed by the identification of the candidate centers themselves. When computing a Canny representation, for example, the system 100 needs only to look in a small neighborhood of the points found previously, minimizing the time needed for this portion of the computation. In practice, each candidate thus identified as a potential traffic light is associated with its score. In one embodiment particularly suitable for tuning a system (e.g., identifying false negatives and false positives), the score is displayed as an overlay on a displayed video image just below the portion thought to be a traffic light, with the highest score in each frame displayed in green, the second highest in blue, and all other possible lights in red.

In testing, it is found that an embodiment as described herein generates no perceptible false negatives (i.e., every traffic light is identified as soon as a human viewing the image can also detect the light). The detection distances are sufficient to allow an autonomous vehicle to make appropriate decisions regarding speed or other considerations.

In practice, it is found that the embodiment described herein does generate false positives, typically taillights or directional blinkers on other vehicles. In practice, however, such false positives are readily identified using existing known methods for determining that such features are not traffic lights. These methods include realizing that the lights are only a few feet off the ground, that they are moving, and that they are in the same location as an automobile or other vehicle. Good automated real-time systems for identifying other vehicles on the road already exist, and 3D mapping module 320 illustrated in FIG. 3 is used in this manner in various embodiments to remove such features identified as artifacts. An additional method using trajectory analysis is also discussed below.

In practice, there may be multiple traffic lights visible in any particular image, and for many applications it does not suffice to simply determine whether or not a light is present; identifying the specific light relevant to the vehicle's direction of travel is also a concern. In most applications, identifying all of the traffic lights in an image is not nearly as important as identifying at least one light relevant to the vehicle's direction of travel. Frame-to-frame differences can be used to help identify traffic lights (as used by the “local” thread analyzing subimages in the neighborhood of lights found in old ones) or remove false positives (as discussed elsewhere herein).

In practical application, the question of whether an image contains a light is somewhat ambiguous. If a detection system is designed to identify lights that are at least 4 pixels in radius, an image with a 3-pixel light should not count as a positive. But it may be desirable to treat an instance with a 4-pixel light as legitimately ambiguous, since a variety of edge effects make it difficult to define the exact size of an object in an image.

In order to address these concerns, in some embodiments the system 100 uses a fundamental “success” metric, i.e., the correct identification of at least one light in any particular image corresponding to the direction of travel of the vehicle in question. The system considers an image to be a positive instance if there is a light in the direction of travel that is at least 4 pixels in radius and at least one light radius away from the edge of the image. The system considers an image to be a negative instance if there is no light larger than 3 pixels in radius visible in the image. Note that some images are simply not considered, since images with lights near the borders cannot in general be expected to be classified correctly by the techniques described herein, and lights between 3 and 4 pixels in size might or might not be classified correctly. Note also that because of the high resolution of the images used and correspondingly wide field of view, the image border is typically a much smaller fraction of the overall image than it is in conventional vehicular camera systems.

Accordingly, a positive instance is considered to be correctly classified (a true positive, in conventional terms) if there is at least one object in the image identified as a traffic light, and if the object with the highest score is indeed a traffic light relevant to the current direction of travel. It is considered incorrectly classified (a false negative) if no traffic light is found. It is considered misclassified (for which there is no conventional analog) if the object identified as the most likely traffic light is not a traffic signal in the current direction of travel.

A negative instance will be said to be correctly classified (a true negative) if either there is no traffic light identified in the image, or a light is correctly identified even though it is smaller than 3 pixels in radius. It will be said to be incorrectly classified (a false negative) if an object other than a traffic light is identified as such in the image.

In testing, a system as described herein was found to generate “apparent” false negatives on approximately 5% of sample images, virtually all of which occurred with the vehicle stopped at a red traffic light (with numerous other red brake lights of other vehicles in the image as well). The vehicle lights, which were false positives, scored higher than the actual traffic light and consumed all of the available “slots” for possible lights, thus resulting in what appears to be a false negative with respect to the actual traffic light. In various embodiments, such brake lights and other artifacts are eliminated from consideration 470, as detailed below.

In various embodiments such issues are addressed in two ways. One is to realize that at some level, the errors being made are ones that do not matter. More specifically, the most dangerous false positives are those where a green light is “seen” even though none exists. The most dangerous false negatives are those where a red light exists but is not noticed.

An alternative is to eliminate such problems by coupling the observations made from frame to frame with GPS information regarding the location of the vehicle, based on which an embodiment determines when a particular “light” is in fact moving. Such lights are obviously not traffic lights, and are eliminated from analysis. Second, accurate information regarding the location and position of the camera is used in some embodiments to automatically exclude “lights” that are in impossible locations (not near a road, too close to the ground, etc.).

The false positives identified in testing in general corresponded to lights on other vehicles. In some embodiments these are eliminated from analysis by recognizing that those vehicles are either moving or too low to be traffic lights. In some embodiments pedestrian signals (e.g., 205) and other artifacts are likewise able to be removed from consideration. Static positional analysis can remove a number of such artifacts.

Another technique, used alternatively or additionally in some embodiments, employs trajectory analysis (via module 330 of FIG. 3) to filter such features from further consideration. Given an object of known size, a candidate region of the image in which that object appears, and knowledge about the (possibly changing) location of the camera that produced the image, it is relatively straightforward to find the point in physical space where the object appears to be located. A series of such points can then be analyzed to determine if the apparent object is likely to correspond to physical reality. This information can be used to both remove objects that might be traffic lights but cannot physically be, and to project the likely location of a light in the next image.

Based on specific applications, some embodiments use one or more methods to implement such processing. Spatial (multiple cameras) and temporal (multiple frames) can be used to help determine location and size of a traffic light in order to position the light in three-dimensional space. Using the temporal example, given a sequence of such locations, the system can find the most likely fixed location for the object in question. A challenge with this approach is that it is often difficult to determine the precise radius of an object in the image, which can lead to significant errors in depth of field (and therefore in positioning generally).

A more accurate approach is to start with a notional position and velocity of a traffic light and to construct an image sequence from that. For a specific presumed position and velocity, the image sequence constructed can then be compared to the images as actually observed. A position and velocity can then be found that jointly minimize the disparity between the images as predicted and observed. In practice, this optimization appears to avoid the difficulty in ranging described in the previous paragraph because large differences in range may correspond to small differences in the size of an object in the image. Small differences of this type will therefore have only minimal impact on the optimization being undertaken. In some embodiments, Levenberg-Marquardt optimization, as described in Moré, J. (1978), The Levenberg-Marquardt algorithm: Implementation and theory, Numerical analysis, 105-116, the contents of which are incorporated by reference as if fully set forth herein, is used to effect the minimization described in this paragraph, thereby computing the likely initial position and velocity of an identified object in a sequence of images.

In some embodiments, such methods as described herein are variously combined with existing methods, for instance those using feeds of real-time traffic light data, as may be warranted in different applications to eliminate, or at least reduce, artifacts in identifying traffic lights. For example, such methods may include, in various applications, those set forth in Ginsberg, M. (2016). Traffic Signals and Autonomous Vehicles: Vision-based or a V21 Approach? Intelligent Transportation Systems, ITSA-16, San Jose, Calif., the contents of which are incorporated by reference as if fully set forth herein.

Thus, both the 3D mapping module 320 and the trajectory analysis module 330 are used, either independently or together, to resolve possible artifacts that might otherwise be considered as possible traffic lights.

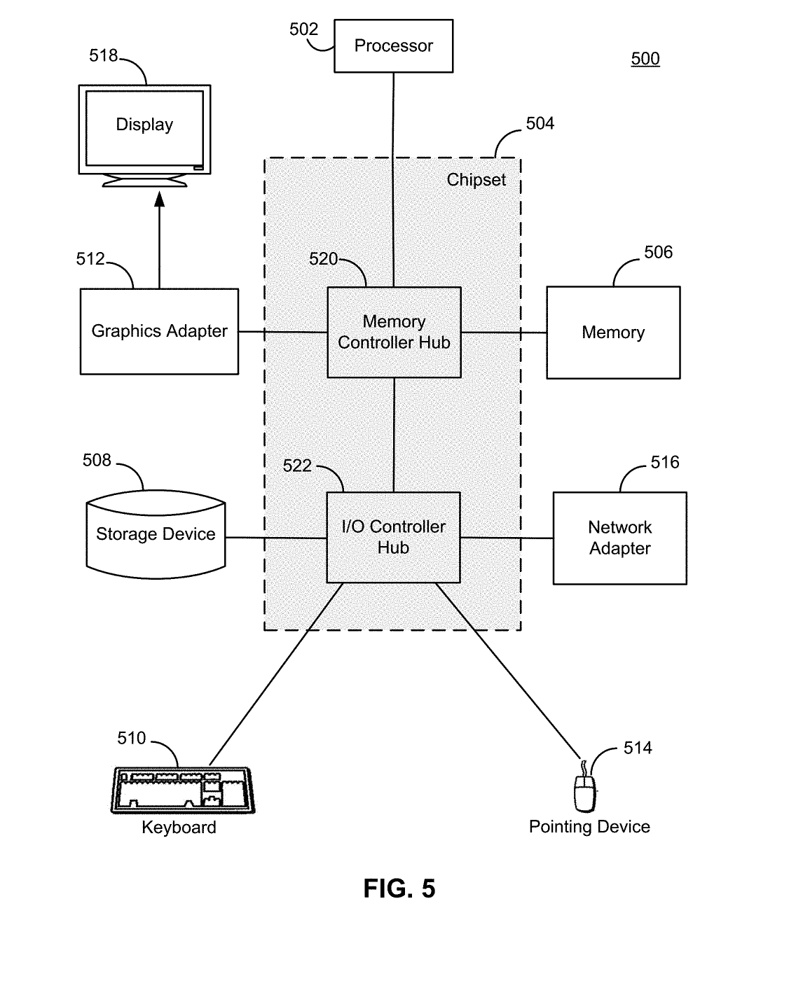

FIG. 5 is a high-level block diagram illustrating an example computer 500 suitable for use in the system 100 (e.g., as data processing device 120 or a processing subsystem within input device 110 or communication unit 130). The example computer 500 includes at least one processor 502 coupled to a chipset 504. The chipset 504 includes a memory controller hub 520 and an input/output (I/O) controller hub 522. A memory 506 and a graphics adapter 512 are coupled to the memory controller hub 520, and a display 518 is coupled to the graphics adapter 512. A storage device 508, keyboard 510, pointing device 514, and network adapter 516 are coupled to the I/O controller hub 522. Other embodiments of the computer 500 have different architectures. For example, in many applications, particularly in autonomous vehicles, there may be no need for a keyboard 510, pointing device 514, display 518 and corresponding graphics adapter 512.

In the embodiment shown in FIG. 5, the storage device 508 is a non-transitory computer-readable storage medium such as a hard drive, compact disk read-only memory (CD-ROM), DVD, or a solid-state memory device. The memory 506 holds computer program code (instructions and data) used by the processor 502. The pointing device 514 is a mouse, track ball, or other type of pointing device, and is used in combination with the keyboard 510 to input data into the computer system 500. The graphics adapter 512 displays images and other information on the display 518. The network adapter 516 couples the computer system 500 to one or more computer networks, such as networks 140 and 150.

The types of computers used by the entities of FIGS. 1-3 can vary depending upon the embodiment and the processing power required by the entity. For example, implementation of input device 110 with such a processor in some embodiments would lack a keyboard 510, and may not include a display 518, while it may have a dedicated video processing subsystem rather than merely a simple graphics adapter for efficiently processing video information. In contrast, the data processing device 120 in many embodiments is a high-performance, multi-processor system optimized for the efficient image processing described above.

Some portions of above description refer to the embodiments in terms of algorithmic processes or operations. These algorithmic descriptions and representations are commonly used by those skilled in the data processing arts to convey the substance of their work effectively to others skilled in the art. These operations are understood to be implemented by hardware systems or subsystems. One of skill in the art will recognize alternative approaches to provide the functionality described herein.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the disclosure. This description should be read to include one or at least one and the singular also includes the plural unless it is obvious that it is meant otherwise.

Upon reading this disclosure, those of skill in the art will appreciate still additional alternative structural and functional designs for a system and a process for image-based identification of traffic lights. Thus, while particular embodiments and applications have been illustrated and described, it is to be understood that the described subject matter is not limited to the precise construction and components disclosed herein and that various modifications, changes and variations which will be apparent to those skilled in the art may be made in the arrangement, operation and details of the method and apparatus disclosed herein. The scope of the invention is to be limited only by the following claims.

What is claimed is:

1. A method of identifying a traffic light in a video from a vehicle's camera, the method comprising:
sending a plurality of frames of the video to a data processing device;
selecting, by the data processing device, a set of candidate portions of each of the plurality of frames corresponding to the traffic light by determining that color space values of the candidate portions are within a range of color space values associated with the traffic light;
pruning the set of candidate portions to reduce false positive results; and
ranking the pruned set of candidate portions to identify a most likely candidate as corresponding to the traffic light.

2. The method of claim 1, further comprising selecting the range of color space values associated with the traffic light by gradually modifying an initial set of values in response to an expected computational expense associated with that set of values.

3. The method of claim 2, wherein gradually modifying is performed in a hill climbing manner such that each modification results in reduced computational expense.

4. The method of claim 1, wherein the selecting for a first subset of the plurality of frames is based on a global analysis of each such frame in its entirety and the selecting for a second subset of the plurality of frames is based on a local analysis of subimages of each such frame, the subimages being identified by the global analysis of a preceding frame from the first subset.

5. The method of claim 1, wherein the selecting, by the data processing device, a set of candidate subimages comprises searching for square objects in each of the plurality of video frames.

6. The method of claim 5, wherein the pruning comprises identifying as most promising, by processing under dynamic programming, a subset of the square objects are identified using dynamic programming.

7. The method of claim 5, wherein the pruning comprises rejecting some of the square objects from further consideration based on determination that certain of the square objects are less useful in identifying the traffic light than others of the square objects.

8. The method of claim 1, wherein the pruning further comprises searching for annular regions of a specific color having locations corresponding to image edges in one of the frames of the video.

9. The method of claim 8, wherein at least some of the image edges are detected using a Canny transform.

10. The method of claim 1, wherein the pruning comprises identifying circular objects in a series of the frames video as corresponding to a single candidate object, computing therefrom a hypothetical trajectory of the single candidate object, and rejecting the single candidate object from further consideration if said trajectory is physically unrealistic as corresponding to the traffic light.

11. The method of claim 10, wherein the computing includes trajectory optimization using Levenberg-Marquardt optimization.

12. The method of claim 10, further comprising conducting a computation of a likely initial position and velocity of the single candidate object by, for a specific presumed position and velocity, constructing a sequence of predicted images, making a comparison between the constructed sequence of predicted images and observed images, and minimizing disparity between the predicted and observed images.

13. A system for identifying a traffic light from a vehicle, comprising:
a camera, disposed at the vehicle, to capture a plurality of images, each of a plural subset of the images including the traffic light;
a data processing device, coupled to the camera by a first data connection, comprising an image analysis module to receive from the camera the plural subset of images, select therefrom a set of candidate portions corresponding to the traffic light by determining that color space values of the candidate portions are within a range of color space values associated with the traffic light, the data processing device configured to prune the set of candidate portions to reduce false positive results, and rank the pruned set of candidate portions to identify a most likely candidate as corresponding to the traffic light; and
a communication unit coupled to the data processing device via a second data connection, the communication unit configured to provide an output indicative of the traffic light.

14. The system of claim 13, wherein the image analysis module comprises a global search module configured to select a first subset of the plurality of frames based on a global analysis of each such frame in its entirety and a local search module configured select a second subset of the plurality of frames based on a local analysis of subimages of each such frame, said subimages identified by the global search module.

15. The system of claim 13, wherein the data processing device further comprises a 3D mapping module configured to search for annular regions of a specific color having locations corresponding to image edges in one of the frames of the video, in order to prune the set of candidate portions.

16. The system of claim 13, wherein the data processing device further comprises a trajectory analysis module configured to identify circular objects in a series of the frames video as corresponding to a single candidate object, compute therefrom a hypothetical trajectory of the single candidate object, and reject the single candidate object from further consideration if said trajectory is physically unrealistic as corresponding to the traffic light.

17. A non-transitory computer-readable medium storing computer program code for identifying a traffic light in a video from a vehicle's camera, the computer program code, when executed, causing one or more processors to perform operations, the operations comprising:
sending a plurality of frames of the video to a data processing device;
selecting, by the data processing device, a set of candidate portions of each of the plurality of frames corresponding to the traffic light by determining that color space values of the candidate portions are within a range of color space values associated with the traffic light;
pruning the set of candidate portions to reduce false positive results; and
ranking the pruned set of candidate portions to identify a most likely candidate as corresponding to the traffic light.

18. The non-transitory computer-readable medium of claim 17, wherein the selecting for a first subset of the plurality of frames is based on a global analysis of each such frame in its entirety and the selecting for a second subset of the plurality of frames is based on a local analysis of subimages of each such frame, the subimages being identified by the global analysis of a preceding frame from the first subset.

19. The non-transitory computer-readable medium of claim 17, wherein the pruning further comprises searching for annular regions of a specific color having locations corresponding to image edges in one of the frames of the video.

20. The non-transitory computer-readable medium of claim 17, wherein the pruning comprises identifying circular objects in a series of the frames video as corresponding to a single candidate object, computing therefrom a hypothetical trajectory of the single candidate object, and rejecting the single candidate object from further consideration if said trajectory is physically unrealistic as corresponding to the traffic light.
